(19) United States
(12) Patent Application Publication
(10) Pub. No.: US 2016/0077392 A1
(43) Pub. Date: Mar. 17, 2016

(54) DISPLAY PANEL

(71) Applicant: Innolux Corporation, Chu-Nan (TW)

(72) Inventors: Jian-Min LEU, Chu-Nan (TW); Yueh-Ting CHUNG, Chu-Nan (TW); Ming-Yo CHIANG, Chu-Nan (TW)

(73) Assignee: Innolux Corporation, Chu-Nan (TW)

(21) Appl. No.: 14/831,865

(22) Filed: Aug. 20, 2015

(30) Foreign Application Priority Data
Sep. 11, 2014 (TW) 103131316

(51) Int. Cl. G02F 1/1343

(52) U.S. Cl. CPC G02F 1/134336; G02F 2001/134345

(57) ABSTRACT

A display panel including a first substrate and a second substrate disposed is provided. The first substrate includes a first data line, a second data line, and a third data line parallel with one another, and a first scan line and a second scan line parallel with each other. The first scan line, the second scan line, the first data line and the second data line define a first sub-pixel. The first scan line, the second scan line, the second data line and the third data line define a second sub-pixel. The first sub-pixel includes a first pixel electrode. The second sub-pixel includes a second pixel electrode. A first interval between the first pixel electrode and the second data line is larger than a second interval between the second pixel electrode and the second data line.

This application claims the benefit of Taiwan application Serial No. 103131316, filed Sep. 11, 2014, the subject matter of which is incorporated herein by reference.

### BACKGROUND OF THE INVENTION

1. Field of the Invention

The invention relates in general to a display apparatus, and more particularly to a display panel.

2. Description of the Related Art

Along with the advance in technology, various types of display have been widely used in the fields such as TV, mobile phone, notebook computer and tablet computer. However, ordinary liquid crystal display panel is restricted by “viewing angle”. The viewer may not watch the display screen along its normal direction. When the viewer watches the display screen along a direction which forms an inclination angle with the display screen rather than along the normal direction which forms a vertical angle with the screen, the light passing through the display panel may be mixed with other different color lights. This phenomenon is referred as “diagonal color cast”.

For example, when the rotation of liquid crystal molecules in the operation region of red sub-pixel is supposed to display a red light, the viewer whose viewing direction is not perpendicular to the screen will experience diagonal color cast because part of the light emitted by the light source passes through adjacent green sub-pixel. When the phenomenon of diagonal color cast occurs, image quality will deteriorate.

### SUMMARY OF THE INVENTION

One embodiment of the invention is directed to a display panel, which, through the structural arrangement of a first substrate, reduces the sub-pixel operation region of a specific primary color (such as red) to reduce light mixing. The variety of the display panel may include FFS display panel, IPS display panel and so on.

According to one embodiment of the invention, a display panel including a first substrate and a second substrate disposed opposed to the first substrate is provided. The first substrate includes a first data line, a second data line, and a third data line parallel with one another, and a first scan line and a second scan line parallel with each other. The first scan line, the second scan line, the first data line and the second data line define a first sub-pixel. The first scan line, the second scan line, the second data line and the third data line define a second sub-pixel. The first sub-pixel includes a first pixel electrode. The second sub-pixel is disposed adjacent to the first sub-pixel and includes a second pixel electrode. A first interval between the first pixel electrode and the second data line is larger than a second interval between the second pixel electrode and the second data line.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a cross-sectional view (in X-Z plane) of a display panel according to an embodiment.

FIG. 2A is a partial top view (in X-Y plane) of a first substrate according to an embodiment.

FIG. 2B is a partial top view (in X-Y plane) of a first substrate according to an embodiment.

FIG. 2C is a partial top view (in X-Y plane) of a first substrate according to an embodiment.

FIG. 2D is a partial top view (in X-Y plane) of a first substrate according to an embodiment.

FIG. 2E is a partial top view (in X-Y plane) of a first substrate according to an embodiment.

FIG. 2F is a partial top view (in X-Y plane) of a first substrate according to an embodiment.

FIG. 3 is a relationship diagram of transmittance vs distance obtained from the simulation of the embodiment illustrated in FIG. 2E according to an embodiment.

FIG. 4 is a relationship diagram of color cast vs viewing angle obtained from the simulation for pixel electrode according to an embodiment.

### DETAILED DESCRIPTION OF THE INVENTION

The embodiments are described in details with reference to the accompanying drawings. The identical elements of the embodiments are designated with the same reference numerals. Also, it is important to point out that the illustrations may not be necessarily drawn to scale, and that there may be other embodiments of the present disclosure which are not specifically illustrated. Thus, the specification and the drawings are regarded as an illustrative sense rather than a restrictive sense.

The embodiment discloses a display panel including a first substrate and a second substrate opposite to the first substrate. The first substrate may include a plurality of data lines and scan lines. The data lines and the scan lines intersect with each other to define a plurality of sub-pixel regions. The sub-pixel regions display such as red color, blue color, and green color. In an embodiment, each of the sub-pixel regions includes pixel electrodes, and the distances between the pixel electrodes and their nearest data lines are not exactly the same.

Details of the invention are disclosed with accompanying drawings in the embodiments below.

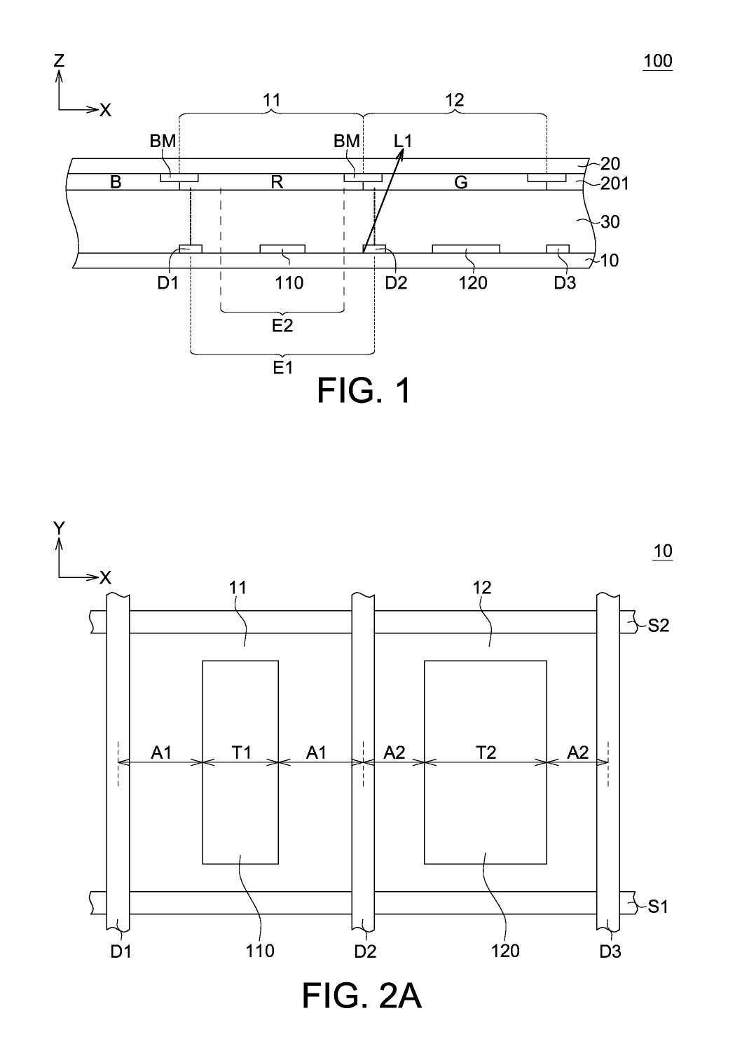

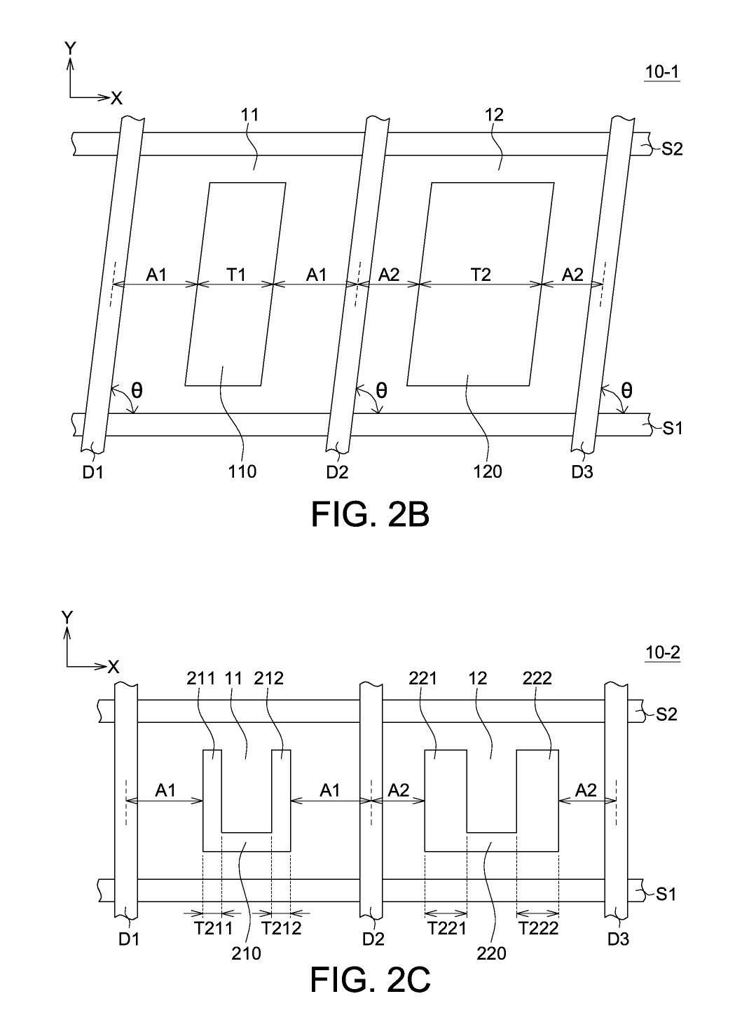

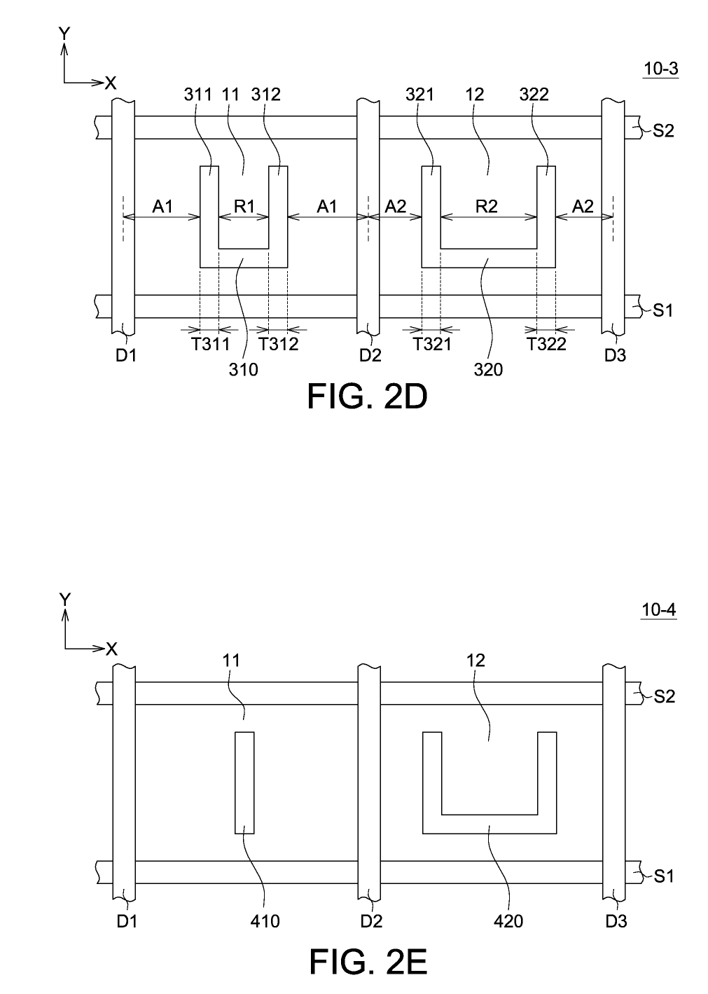

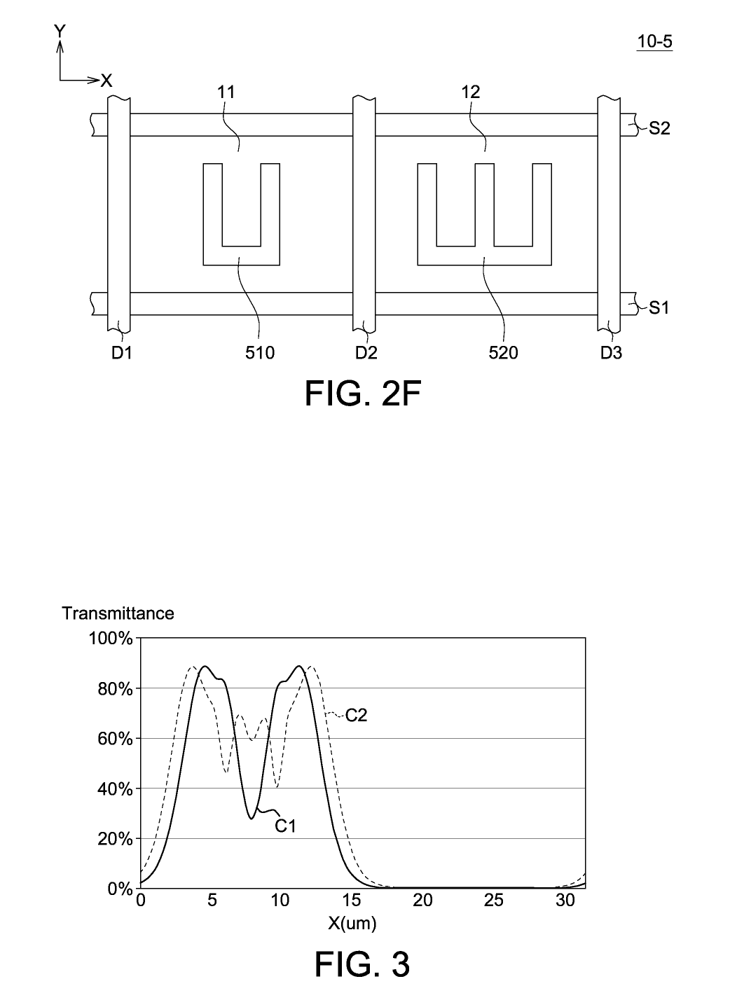

FIG. 1 is a cross-sectional view (in X-Z plane) of a display panel 100 according to an embodiment. FIG. 2A is a partial top view (in X-Y plane) of a first substrate 10 according to an embodiment. As indicated in FIG. 1 and FIG. 2A, the display panel 100 includes the first substrate 10 and a second substrate 20 opposite to the first substrate 10. A liquid crystal layer 30 is disposed between the first substrate 10 and the second substrate 20.

The second substrate 20 includes a color filter layer 201. The first substrate 10 may include a first data line D1, a second data line D2, a third data line D3, a first scan line S1 and a second scan line S2. The first data line D1, the second data line D2 and the third data line D3 extend along a first direction and are adjacent to one another. For example, the first data line D1, the second data line D2 and the third data line D3 may be parallel with one another. The first scan line S1 and the second scan line S2 extend along a second direction and are adjacent to each other. For example, the first scan line S1 and the second scan line S2 may be parallel with each other. In the present embodiment, the first direction is, for example, the Y direction, and the second direction is, for example, the X direction. That is, the first direction may be perpendicular to the second direction.

In the present embodiment, the first scan line S1, the second scan line S2, the first data line D1 and the second data line D2 define a first sub-pixel 11; the first scan line S1, the second scan line S2, the second data line D2 and the third data line D3 define a second sub-pixel 12. The first sub-pixel 11 includes a first pixel electrode 110. The second sub-pixel 12 is disposed adjacent to the first sub-pixel 11, and includes a second pixel electrode 120. Besides, the color filter layer 201 may include a red filter pattern R, a blue filter pattern B and a green filter pattern G. In the embodiment, the red filter pattern R corresponds to the first sub-pixel 11.

As indicated in FIG. 2A, a first interval A1 between the first pixel electrode 110 and its nearest data lines (D1, D2) along the second direction (X direction) is larger than a second interval A2 between the second pixel electrode 120 and its nearest data lines (D2, D3) along the second direction. According to an embodiment of the invention, the first pixel electrode 110 may be disposed in the middle between the first data line D1 and the second data line D2, so that the first pixel electrode 110 is separated from the first data line D1 and the second data line D2 by the same interval being the first interval A1. Similarly, since the second pixel electrode 120 may be disposed in the middle between the second data line D2 and the third data line D3, the second pixel electrode 120 is separated from the second data line D2 and the third data line D3 by the same interval being the second interval A2.

In a conventional display panel, the first interval A1 between the first pixel electrode of the first sub-pixel 11 and its nearest data line is equivalent to the second interval A2 between the second pixel electrode of the second sub-pixel 12 and its nearest data line. Meanwhile, the operation region of the first sub-pixel 11 is such as the region E1 as illustrated in FIG. 1.

In the display panel 100 of the embodiment according to the invention, the width T1 of the first pixel electrode 110 is smaller than the width T2 of the second pixel electrode 120, such that the first interval A1 is larger than the second interval A2. The operation region of the first sub-pixel 11 is such as the region E2 as Illustrated in FIG. 1. As indicated in FIG. 1, the region E2 is smaller than the region E1. Since the first sub-pixel 11 of the embodiment according to the invention has a smaller operation region, when a light L1 is emitted towards an inclined direction as indicated in FIG. 1, light mixing will be greatly reduced, and the phenomenon of diagonal color cast will be effectively avoided.

Although the embodiment illustrated in FIG. 2A is elaborated using the exemplification that the first scan line S1 and the second scan line S2 are perpendicular to the first data line D1, the second data line D2 and the third data line D3, the invention is not limited thereto. FIG. 2B is a partial top view (in X-Y plane) of a first substrate 10-1 according to an embodiment. As indicated in FIG. 2B, the first data line D1, the second data line D2 and the third data line D3 may be inclined, and an angle θ between the first data line D1 (or the second data line D2, the third data line D3) and the first scan line S1 (or the second scan line S2) may be such as between 0 and 90°. Moreover, the shapes of the first pixel electrode 110 and the second pixel electrode 120 may match the first data line D1, the second data line D2 and the third data line D3 and tilt as a parallelogram.

Similarly, in the embodiment illustrated in FIG. 2B, the first interval A1 is larger than the second interval A2. It should be noted that the first interval A1 is defined as the interval by which the first pixel electrode 110 is separated from its nearest data lines (D1, D2) along the second direction (X direction), and the second interval A2 is defined as the interval by which the second pixel electrode 120 is separated from its nearest data lines (D2, D3) along the second direction.

Moreover, the shapes of the first pixel electrode 110 and the second pixel electrode 120 are not limited to the shapes illustrated in above embodiments.

FIG. 2C is a partial top view (in X-Y plane) of a first substrate 10-2 according to an embodiment. The present embodiment is different from previous embodiments in that the first pixel electrode 210 includes a first branch electrode 211 and a second branch electrode 212, and the width T211 of the first branch electrode 211 is equivalent to the width T212 of the second branch electrode 212. The second pixel electrode 220 includes a third branch electrode 221 and a fourth branch electrode 222, and the width T221 of the third branch electrode 221 is equivalent to the width T222 of the fourth branch electrode 222.

In one embodiment, the first branch electrode 211 may be substantially parallel with the second branch electrode 212, and the third branch electrode 221 may be substantially parallel with the fourth branch electrode 222. Further, the first branch electrode 211, the second branch electrode 212, the third branch electrode 221 and the fourth branch electrode 222 may be substantially parallel with the first data line D1, the second data line D2 and the third data line D3. Here, the term “substantially” is used because of the process errors.

In the present embodiment, the width T211 of the first branch electrode 211 and the width T212 of the second branch electrode 212 of the first pixel electrode 210 are smaller than the width T221 of the third branch electrode 221 and the width T222 of the fourth branch electrode 222 of the second pixel electrode 220.

Similarly, a first interval A1 between the first pixel electrode 210 and its nearest data lines (D1, D2) is larger than a second interval A2 between the second pixel electrode 220 and its nearest data lines (D2, D3). In the embodiment illustrated in FIG. 2C, the first interval A1 may be defined as the interval by which the first branch electrode 211 is separated from the first data line D1 along the second direction (X direction) or the interval by which the second branch electrode 212 is separated from the second data line D2 along the second direction. The second interval A2 may be defined as the interval by which the third branch electrode 221 is separated from the second data line D2 along the second direction or the interval by which the fourth branch electrode 222 is separated from the third data line D3 along the second direction.

FIG. 2D is a partial top view (in X-Y plane) of a first substrate 10-3 according to an embodiment. Similar to the embodiment illustrated in FIG. 2C, the first pixel electrode 310 of the embodiment according to the invention may include a first branch electrode 311 and a second branch electrode 312, and the width T311 of the first branch electrode 311 is equivalent to the width T312 of the second branch electrode 312. The second pixel electrode 320 includes a third branch electrode 321 and a fourth branch electrode 322, and the width T321 of the third branch electrode 321 is equivalent to the width T322 of the fourth branch electrode 322. The first branch electrode 311, the second branch electrode 312, the third branch electrode 321 and the fourth branch electrode 322 may be substantially parallel with the first data line D1, the second data line D2 and the third data line D3.

In the embodiment of the invention, a first distance R1 between the first branch electrode 311 and the second branch electrode 312 of the first pixel electrode 310 is smaller than a second distance R2 between the third branch electrode 321 and the fourth branch electrode 322 of the second pixel electrode 320.

Although the embodiments illustrated in FIG. 2C and FIG. 2D are elaborated using the exemplification that the first pixel electrodes (210, 310) and the second pixel electrodes (220, 320) respectively have two branch electrodes, the invention is not limited thereto. FIG. 2E is a partial top view (in X-Y plane) of a first substrate 10-4 according to an embodiment. As indicated in FIG. 2E, the first pixel electrode 410 does not includes any branch electrode, but the second pixel electrode 420 includes two branch electrodes.

In other embodiments, the first pixel electrode and the second pixel electrode may respectively have a plurality of branch electrodes, and the number of branch electrodes of the first pixel electrode is smaller than the number of branch electrodes of the second pixel electrode. FIG. 2F is a partial top view (in X-Y plane) of a first substrate 10-5 according to an embodiment. As indicated in FIG. 2F, the first pixel electrode 510 may have two branch electrodes, and the second pixel electrode 520 may have three branch electrodes. That is, in the embodiment of the invention, the number of branch electrodes of the first pixel electrode and the number of branch electrodes of the second pixel electrode may depend on actual needs of the design.

It can be understood from above embodiments that through the design in the width of the first pixel electrode and the width of the second pixel electrode, and the width and number of the branch electrodes thereof, the first interval A1 between the first pixel electrode and its nearest data line may be different from the second interval A2 between the second pixel electrode and its nearest data line. Through such structural arrangement, the operation region of the specific primary color (such as the operation region of the first sub-pixel 11 illustrated in each of the above embodiments) can be reduced to greatly reduce the light of the present sub-pixel being mixed with the light of an adjacent sub-pixel and effectively avoid the phenomenon of diagonal color cast.

It is understood that structural characteristics of each of the above embodiments, such as the width of the first pixel electrode and the width of the second pixel electrode, and the width and number of branch electrodes thereof, may be individually, partly or totally realized in the same display panel. Any structural characteristics, which may enable the distance between the first pixel electrode of the first sub-pixel and its nearest data line to be different from the distance between the second pixel electrode of the second sub-pixel and its nearest data line, are within the scope of protection of the embodiment of the invention.

Since human eyes are more sensitive to the color cast of red color than other colors, the first sub-pixel 11 may display red color, and the second sub-pixel 12 may display blue color or green color in the embodiment according to the invention. Besides, the first interval A1 between the first pixel electrode of the first sub-pixel 11 and its nearest data line (such as the first data line D1 or the second data line D2) is larger than the second interval A2 between the second pixel electrode of the second sub-pixel 12 and its nearest data line (such as the second data line D2 or the third data line D3), such that the operation region of the first sub-pixel 11 is reduced to greatly reduce the light of the first sub-pixel 11 being mixed with the light of its adjacent second sub-pixel 12 and effectively avoid the phenomenon of diagonal color cast.

In above embodiments of the invention, each of the first pixel electrodes 110, 210, 210, 310, 410 and 510, the second pixel electrodes 120, 220, 320, 420, and 520, the first branch electrodes 211 and 311 and the second branch electrodes 212 and 312 of the first pixel electrodes 210 and 310, and the third branch electrodes 221 and 321 and the fourth branch electrodes 222 and 322 of the second pixel electrodes 220 and 320 may have a width between 0.5 and 5 μm.

In addition, the first substrates 10-1 to 10-5 as illustrated in FIG. 2B to FIG. 2F are different embodiments of the invention and may be used as different implementations of the first substrate 10 as illustrated in FIG. 1. That is, the first substrates 10-1 to 10-5 illustrated in FIG. 2B to FIG. 2F may replace the first substrate 10 as illustrated in FIG. 1 used in the display panel of different embodiments according to the invention. However, the implementation of the invention is not limited to the above embodiments.

FIG. 3 is a relationship diagram of transmittance vs distance obtained from the simulation of the embodiment illustrated in FIG. 2E according to an embodiment. In FIG. 3, ‘distance’ is defined as the distance from the center of the first pixel electrode 410 to the center of the first data line D1. Curve C1 represents the simulation results for the first pixel electrode 410 illustrated in FIG. 2E. The first pixel electrode 410 does not have any branch electrode. Curve C2 represents the simulation results for the second pixel electrode 420 illustrated in FIG. 2E. The second pixel electrode 420 has two branch electrodes. As indicated in FIG. 3, it is obvious that curve C1 has a narrower distribution of transmittance than curve C2. That is, as the number of branch electrodes of the pixel electrode decreases, the operation region of the pixel will reduce accordingly.

Table 1 below shows the results of the simulation test of light mixing using the pixel electrode of the embodiment according to the invention. In this simulation test, a comparison between the first pixel electrode 410 (not having any branch electrode) illustrated in FIG. 2E and the second pixel electrode 420 (having two branch electrodes) illustrated in FIG. 2E is shown in Table 1. In Table 1, MA (μm) is a measurement of misalignment between the first substrate 10 and the second substrate 20, for example, the misalignment between the first data line D1 on the first substrate 10 and the black matrix BM (shown in FIG. 1) on the second substrate 20; dHuv (°) is a measurement of the amount of color cast.

TABLE 1

| | dHuv (°) of the first pixel | dHuv (°) of the second |
|---|---|---|
| MA (μm) | electrode 410 | pixel electrode 420 |
| 0 | 1.73 | 2.09 |
| 1 | 4.34 | 5.02 |
| 2 | 13.63 | 16.23 |
| 3 | 35.28 | 41.14 |

It can be known from the result of the simulation shown in Table 1, regardless of the misalignment between the first substrate 10 and second substrate 20, the amount of color cast dHuv (°) of the first pixel electrode 410 (not having any branch electrode) is smaller than the amount of color cast dHuv (°) of the second pixel electrode 420 (having two branch electrodes).

Likewise, the simulation test of transmittance for the first pixel electrode 410 and the second pixel electrode 420 shows that the overall transmittance of the first pixel electrode 410 (not having any branch electrode) is merely lower than the overall transmittance of the second pixel electrode 420 (having two branch electrodes) by about 1%. That is, the decrease in the number of branch electrodes of the pixel electrode reduces the amount of color cast without causing too much decrease to the overall transmittance.

If the operation regions of the first sub-pixel 11 and the second sub-pixel 12 are reduced at the same time, the light mixing between adjacent sub-pixels may also be reduced. However, the overall transmittance will drop too much and the image quality will deteriorate accordingly. Therefore, the structural arrangement of the embodiment according to the invention not only effectively reduces the light mixing between adjacent sub-pixels but also maintains a satisfactory level of transmittance.

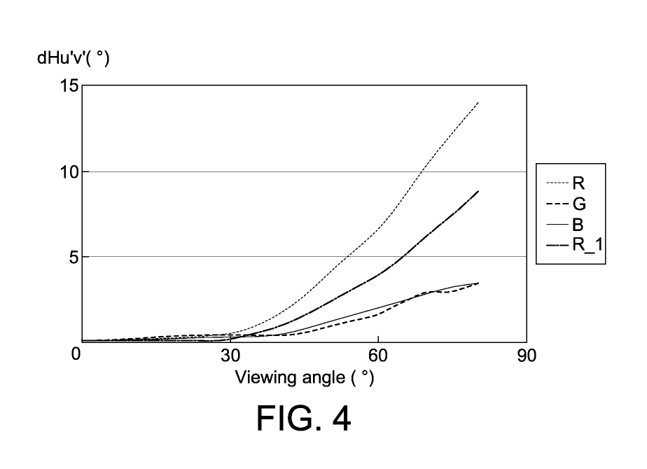

FIG. 4 is a relationship diagram of color cast vs viewing angle obtained from the simulation for pixel electrode according to an embodiment. Curves R and R_1 respectively represent the simulation result for the first pixel electrode 210 (having two branch electrodes, that is, the first branch electrode 211 and the second branch electrode 212) illustrated in FIG. 2C and the simulation result for the first pixel electrode 110 (not having any branch electrode) illustrated in FIG. 2A. Curves R and R_1 correspond to the region in which the sub-pixel emits red light; curve G corresponds to the region in which the sub-pixel emits green light; curve B corresponds to the region in which the sub-pixel emits blue light. Curve G and curve B may represent the simulation result for the structure such as the second pixel electrode 120 illustrated in FIG. 2A.

It can be understood from FIG. 4 that as the viewing angle tilts to a larger angle, the sub-pixel region emitting red light (curve R and R_1) will generate a larger amount of color cast than the sub-pixel region emitting blue light and the sub-pixel region emitting green light (curve B and curve G). Besides, under the same viewing angle, the amount of color cast of curve R_1 is obviously smaller than that of curve R. That is, the decrease in the number of branch electrodes of the pixel electrode effectively reduces the amount of color cast.

It can be known from the above embodiments and simulation experiments that when the intervals between the pixel electrodes of the sub-pixel region and their nearest data lines are not exactly the same, the operation region of the sub-pixel of a specific primary color (such as red) may be reduced to greatly reduce light mixing and effectively avoid the phenomenon of diagonal color cast. Meanwhile, the overall transmittance will not drop too much and the image quality will not be affected.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display panel, comprising a first substrate and a second substrate opposite to the first substrate, wherein the first substrate comprises:
a first sub-pixel comprising a first pixel electrode;
a second sub-pixel disposed adjacent to the first sub-pixel and comprising a second pixel electrode;
a first data line, a second data line and a third data line extending along a first direction and adjacent to one another; and
a first scan line and a second scan line extending along a second direction and adjacent to each other, wherein the first sub-pixel is defined by the first scan line, the second scan line, the first data line and the second data line, and the second sub-pixel is defined by the first scan line, the second scan line, the second data line and the third data line;
wherein a first interval between the first pixel electrode and the second data line is larger than a second interval between the second pixel electrode and the second data line.

2. The display panel according to claim 1, wherein a width of the first pixel electrode is smaller than a width of the second pixel electrode.

3. The display panel according to claim 1, wherein the first pixel electrode comprises a plurality of branch electrodes and the second pixel electrode comprises a plurality of branch electrodes, the branch electrodes of the first pixel electrode are substantially parallel each other, and the branch electrodes of the second pixel electrode are substantially parallel each other.

4. The display panel according to claim 3, wherein the first pixel electrode comprises two branch electrodes, and the second pixel electrode comprises two branch electrodes.

5. The display panel according to claim 4, wherein each of the branch electrodes of the first pixel electrode has a first width, each of the branch electrodes of the second pixel electrode has a second width, and the first width is smaller than the second width.

6. The display panel according to claim 3, wherein the branch electrodes of the first pixel electrode and the second pixel electrode are substantially parallel with the first data line, the second data line and the third data line.

7. The display panel according to claim 4, wherein a first distance between the branch electrodes of the first pixel electrode is smaller than a second distance between the branch electrodes of the second pixel electrode.

8. The display panel according to claim 1, wherein the first pixel electrode and the second pixel electrode respectively have a plurality of branch electrodes, and a number of the branch electrodes of the first electrode is smaller than a number of the branch electrodes of the second electrode.

9. The display panel according to claim 1, wherein the first sub-pixel displays red color.

10. The display panel according to claim 3, wherein each branch electrode of the first pixel electrode and the second pixel electrode has a width between 0.5 and 5 μm.

11. The display panel according to claim 8, wherein each branch electrode of the first pixel electrode and the second pixel electrode has a width between 0.5 and 5 μm.

12. The display panel according to claim 1, further comprising:
a liquid crystal layer disposed between the first substrate and the second substrate.
